(19) United States
(12) Patent Application Publication
(10) Pub. No.: US 2012/0054697 A1
(43) Pub. Date: Mar. 1, 2012

(54) LIGHT SOURCE SHAPE CALCULATION METHOD

(76) Inventors: Kazuhiro TAKAHATA, Kanagawa (JP); Tetsuaki MATSUNAWA, Kanagawa (JP); Masahiro MIYAIRI, Kanagawa (JP); Shimon MAEDA, Tokyo (JP); Shigeki NOJIMA, Kanagawa (JP)

(21) Appl. No.: 13/222,016

(22) Filed: Aug. 31, 2011

(30) Foreign Application Priority Data
Sep. 1, 2010 (JP) 2010-196034

(51) Int. Cl. G06F 17/50

(52) U.S. Cl. 716/55

(57) ABSTRACT

According to one embodiment, a light source shape calculation method includes calculating a first light source shape as an exposure illumination light source shape, so that the first light source shape has a light source shape region symmetrical to an X-axis direction and a Y-axis direction, and a process margin when forming an on-substrate pattern corresponding to at least two pattern layouts defined by design rules is optimized. A point light source is calculated such that the process margin of formation of the on-substrate pattern corresponding to a pattern layout to be formed on a semiconductor device is optimized, and is applied to the first light source shape.

### CROSS-REFERENCE TO RELATED APPLICATIONS

This application is based upon and claims the benefit of priority from the prior Japanese Patent Application No. 2010-196034, filed on Sep. 1, 2010; the entire contents of which are incorporated herein by reference.

### FIELD

Embodiments described herein relate generally to a light source shape calculation method.

### BACKGROUND

A photolithography process is one of processes for use in manufacturing semiconductor devices. In the photolithography process, it is important to optimize illumination conditions (the shape of a light source and the like) of an illumination source used for exposure. For example, a technique that optimizes the illumination light source shape through simulation is an example of the method of optimizing illumination conditions. According to source mask optimization (SMO) which is an example of the illumination condition optimization method, various patterns within the range of the design rules are input, and the source and mask shapes which maximize the process margins of the input patterns are calculated through simulation.

However, the illumination condition optimization method using the SMO just optimizes a light source shape (a set of point sources) so as to maximize the process margins of the finite types of input patterns. Therefore, the light source shape is not optimized for all patterns allowed by the design rules. Thus, it is desirable that the light source shape is optimized for all patterns allowed by the design rules.

### BRIEF DESCRIPTION OF THE DRAWINGS

FIG. 1 is a block diagram showing the configuration of a light source shape calculation device according to a first embodiment;

FIG. 2 is a flowchart showing the processing procedures of a light source shape calculation process according to the first embodiment;

FIGS. 3A to 3C are views showing examples of a contact hole pattern used as an allowed pattern;

FIG. 4 is a view illustrating light intensity set to a light source;

FIGS. 5A to 5C are views showing examples of an annular light source shape calculated by the light source shape calculation device according to the first embodiment;

FIGS. 6A to 6E are views showing examples of a line-and-space pattern used as an allowed pattern;

FIGS. 7A to 7C are views showing examples of a four-eyed light source shape calculated by the light source shape calculation device;

FIG. 8 is a view showing an example of another light source shape configured to include an annular light source shape;

FIGS. 9A to 9C are views showing examples of another light source shape configured to include the four-eyed light source shape;

FIG. 10 is a block diagram showing the configuration of a light source shape calculation device according to a second embodiment;

FIG. 11 is a flowchart showing the processing procedures of a light source shape calculation process according to the second embodiment;

FIGS. 12A to 12C are views showing examples of an annular light source shape calculated by the light source shape calculation device according to the second embodiment; and

FIG. 13 is a view showing a hardware configuration of the light source shape calculation device.

### DETAILED DESCRIPTION

In general, according to one embodiment, a light source shape calculation method includes calculating a first light source shape as an exposure illumination light source shape based on at least two pattern layouts defined by design rules used when manufacturing a semiconductor device so that the first light source shape has a light source shape region symmetrical to an X-axis direction and a Y-axis direction, and a process margin when forming an on-substrate pattern corresponding to the at least two pattern layouts is optimized. The method further includes adding a pattern layout to be formed on the semiconductor device to the at least two pattern layouts to thereby create a combined pattern layout. The method further includes calculating a point light source based on the combined pattern layout so that the process margin when forming the on-substrate pattern corresponding to the pattern layout formed on the semiconductor device is optimized. The method further includes calculating a second light source shape in which the point light source is added to the first light source shape.

Exemplary embodiments of a light source shape calculation method will be explained below in detail with reference to the accompanying drawings. The present invention is not limited to the following embodiments.

### First Embodiment

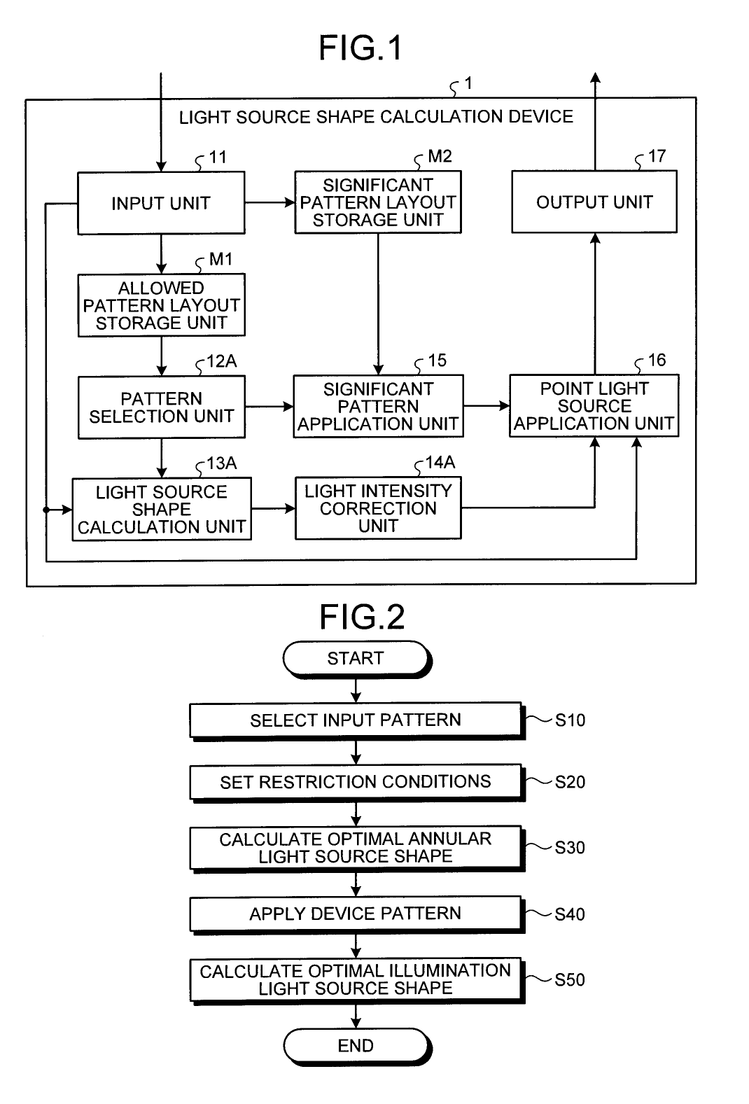

FIG. 1 is a block diagram showing the configuration of a light source shape calculation device according to a first embodiment. A light source shape calculation device 1 is a computer or the like that derives the light source shape of an exposure illumination used in an exposure apparatus (exposure process) during a lithography process.

The light source shape calculation device 1 of the present embodiment calculates a first light source shape that is symmetric in all directions based on at least two pattern layouts (allowed patterns) allowed by the design rules. After that, the light source shape calculation device 1 adds a pattern layout (important pattern) that is important in an integrated circuit to the allowed patterns. Moreover, the light source shape calculation device 1 applies a new point light source corresponding to the important pattern to the first light source shape based on the combined pattern to thereby calculate a second light source shape. The light source shape described in the present embodiment includes the position, shape, and light intensity of a light source.

The light source shape calculation device 1 includes an input unit 11, a pattern selection unit 12A, a light source shape calculation unit 13A, a light intensity correction unit 14A, an important pattern application unit 15, a point light source application unit 16, an output unit 17, an allowed pattern layout storage unit M1, and an important pattern layout storage unit M2.

The input unit 11 inputs various allowed patterns allowed by the design rules, an important pattern in an integrated circuit, restriction conditions regarding exposure, and the like. The input unit 11 sends the input allowed patterns to the allowed pattern layout storage unit M1 and sends the input important pattern to the important pattern layout storage unit M2. Moreover, the input unit 11 sends the input restriction conditions to the light source calculation unit 13A and the point light source application unit 16.

The allowed pattern layout storage unit M1 is a memory or the like storing the allowed patterns, and the important pattern layout storage unit M2 is a memory or the like storing the important pattern. The allowed patterns and the important pattern transferred to a substrate may be a contact hole pattern and may be a line-and-space pattern.

When the allowed pattern is a contact hole pattern, the allowed pattern includes contact hole patterns having various sizes allowed by the design rules and various arrangement pitches (spaces).

Moreover, when the allowed pattern is a line-and-space pattern, line patterns with various widths and arrangement pitches (spaces) are the allowed patterns allowed by the design rules.

As described above, the allowed pattern includes a pattern (dense pattern) of which the pattern pitch is small and a pattern (isolated pattern) of which the pattern pitch is large. In other words, the allowed pattern includes a pattern layout in which the pattern density is high and a pattern layout in which the pattern density is low. In the present embodiment, a pattern layout having at least two pattern pitches is used as the allowed pattern.

The pattern selection unit 12A selects a pattern layout used for optimizing a light source shape from among the allowed patterns stored in the allowed pattern layout storage unit M1. For example, the pattern selection unit 12A selects a pattern layout having the maximum pattern pitch, a pattern layout having the minimum pattern pitch, a pattern layout having the average pattern pitch, a pattern pitch having the dominant pattern pitch, and the like from among the allowed patterns. The pattern selection unit 12A sends the selected pattern layout to the light source shape calculation unit 13A and the important pattern application unit 15.

The light source shape calculation unit 13A calculates a light source shape (for example, an annular light source shape, a four-eyed light source shape, and the like) having a light source shape region that is symmetric in the X-axis direction and the Y-axis direction based on the restriction conditions. In the following description, although a case of calculating an annular light source shape has been described, the calculated light source shape may be a four-eyed light source shape or the like.

The light source shape calculation unit 13A calculates an annular light source shape having a light source shape of which the light intensity is uniform and which is continuous within a plane through simulation so as to obtain a common process margin (the process margin when forming a pattern) that is optimal to a plurality of kinds of pattern layouts (allowed pattern) selected by the pattern selection unit 12A. In other words, the light source shape calculation unit 13A calculates the annular light source shape so that dimensional fluctuation of a pattern formed on a wafer is minimized. The light source shape calculation unit 13A sends the calculated annular light source shape to the light intensity correction unit 14A.

The light intensity correction unit 14A corrects the light intensity of the calculated annular light source shape. For example, the light intensity correction unit 14A corrects the light intensity of the annular light source shape by decreasing the light intensity of the annular light source shape from 1.0 to 0.5. The light intensity correction unit 14A sends the annular light source shape of which the light intensity is corrected to the point light source application unit 16 as a corrected annular light source shape P.

The important pattern application unit 15 reads the important pattern from the important pattern layout storage unit M2. Examples of the important pattern include a frequent pattern layout, an important circuit pattern layout, and an internal memory pattern such as a SRAM pattern which is likely to be formed as a smaller pattern than a logical circuit pattern. The important pattern application unit 15 applies the pattern layout of the important pattern to the pattern layout of the allowed pattern sent from the pattern selection unit 12A. The important pattern application unit 15 sends the allowed pattern (hereinafter referred to as a combined allowed pattern) to which the important pattern is applied to the point light source application unit 16.

The point light source application unit 16 calculates a new annular light source shape (optimized annular light source shape Q) based on the restriction conditions, the corrected annular light source shape P, and the combined allowed pattern. The point light source application unit 16 applies a point light source to the corrected annular light source shape P to thereby calculate the position and light intensity of the point light source capable of optimizing the process margin of the important pattern through simulation. The point light source application unit 16 sends the corrected annular light source shape P to which the calculated point light source is applied to the output unit 17 as the optimized annular light source shape Q. The output unit 17 outputs the optimized annular light source shape Q to an external device such as an exposure apparatus.

Next, the processing procedures of a source shape calculation process will be described. FIG. 2 is a flowchart showing the processing procedures of a light source shape calculation process according to the first embodiment. The allowed pattern, the important pattern, the restriction conditions regarding exposure and the like are input to the input unit 11 of the light source shape calculation device 1.

The input unit 11 sends allowed patterns to the allowed pattern layout storage unit M1 so as to be stored in the allowed pattern layout storage unit M1. Moreover, the input unit 11 sends an important pattern to the important pattern layout storage unit M2 so as to be stored in the important pattern layout storage unit M2. Moreover, the input unit 11 sends the input restriction conditions to the light source shape calculation unit 13A and the point light source application unit 16.

The pattern selection unit 12A selects a pattern layout (input pattern) used for optimizing the light source shape from among the allowed patterns stored in the allowed pattern layout storage unit M1 (step S10).

For example, the pattern selection unit 12A selects a pattern layout having various (for example, several to several tens of) pattern pitches from among the allowed patterns. The pattern selection unit 12A sends the selected pattern layout to the light source shape calculation unit 13A and the important pattern application unit 15.

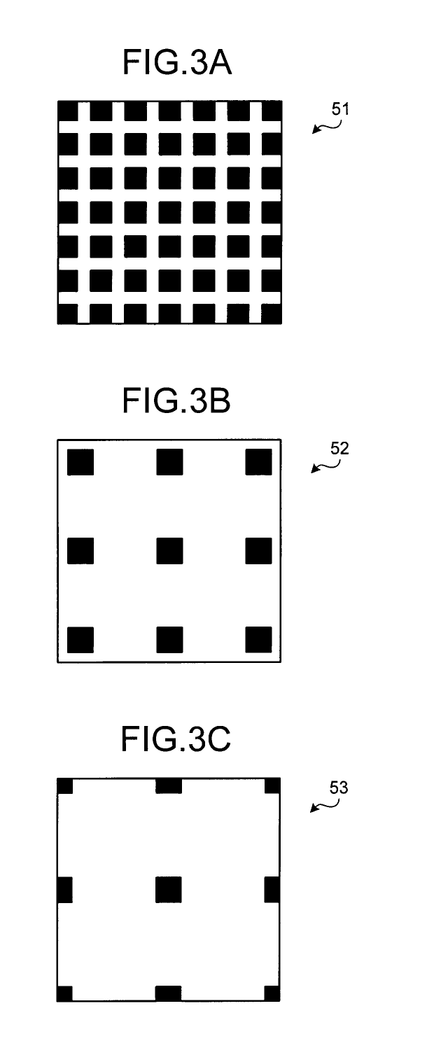

Here, an allowed pattern will be described. In this example, a case where the allowed pattern is a contact hole pattern will be described. FIGS. 3A to 3C are views showing examples of a contact hole pattern used as an allowed pattern. FIGS. 3A to 3C show the pattern layouts of a contact hole pattern.

FIG. 3A shows a contact hole pattern 51 having a small pattern pitch, and FIG. 3C shows a contact hole pattern 53 having a large pattern pitch. Moreover, FIG. 3B shows a contact hole pattern 52 having an middle pattern pitch.

The light source shape calculation unit 13A sets the restriction conditions regarding exposure (step S20). For example, the restriction conditions regarding exposure include exposure conditions applied to an exposure apparatus, characteristics of the exposure apparatus, and mask types. The exposure conditions include numerical aperture (NA). Moreover, the characteristics of an exposure apparatus include vertical movement accuracy of a stage on which a wafer is placed. Moreover, the mask types include a transmittance or phase of patterns. The restriction conditions may be set before the input pattern is selected.

The light source shape calculation unit 13A calculates an optimal annular light source shape based on the restriction conditions through simulation so that all of the respective pattern layouts selected from among the allowed patterns have a predetermined level of process margin or higher (step S30). In this case, the light source shape calculation unit 13A calculates the annular light source shape of which the light intensity is uniform and which is continuous within a plane. The light source shape calculation unit 13A sends the calculated annular light source shape to the light intensity correction unit 14A.

The light intensity correction unit 14A corrects the calculated light intensity of the annular light source shape. For example, the light intensity correction unit 14A corrects the light intensity of the annular light source shape by decreasing the respective light intensities of the annular light source shapes by a predetermined proportion. The light intensity correction unit 14A may correct the light intensity of the annular light source shape by decreasing the respective light intensities of the annular light source shapes by a predetermined value. The light intensity correction unit 14A sends the annular light source shape of which the light intensity is corrected to the point light source application unit 16 as a corrected annular light source shape P.

The important pattern application unit 15 reads the important pattern from the important pattern layout storage unit M2. The important pattern application unit 15 applies the pattern layout (device pattern) of the important pattern to the pattern layout of the allowed pattern sent from the pattern selection unit 12A (step S40). The important pattern application unit 15 sends the important pattern and the allowed pattern (combined allowed pattern) to which the important pattern is applied to the point light source application unit 16.

The point light source application unit 16 calculates an optimized annular light source shape Q (optimized illumination light source shape) based on the restriction conditions, the important pattern, the corrected annular light source shape P, and the combined allowed pattern (step S50). The point light source application unit 16 applies a point light source to the corrected annular light source shape P to thereby calculate the position and light intensity of the point light source capable of making the process margin of the important pattern have a predetermined value or more (optimal value) through simulation. In this case, the point light source of which the light intensities are added together is calculated while maintaining the light intensity of the corrected annular light source shape P.

In other words, the position and light intensity of the point light source capable of optimizing the process margin of the important pattern are calculated. As described above, in the present embodiment, the necessary light intensity is enhanced by applying the point light source to the calculated corrected annular light source shape P. In this way, the light source shape of an illumination source used for an exposure process is constructed.

The point light source application unit 16 sends the corrected annular light source shape P to which the calculated point light source is applied to the output unit 17 as the optimized annular light source shape Q. The output unit 17 outputs the optimized annular light source shape Q to an external device such as an exposure apparatus.

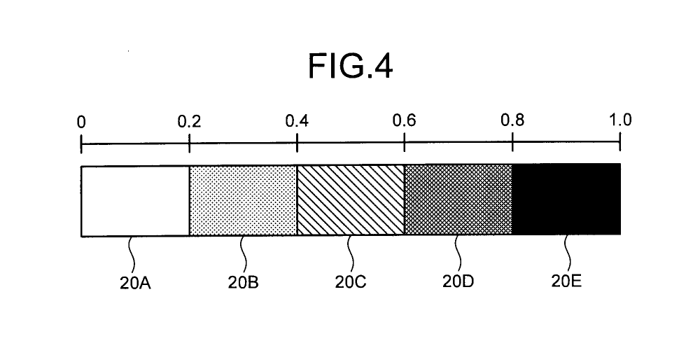

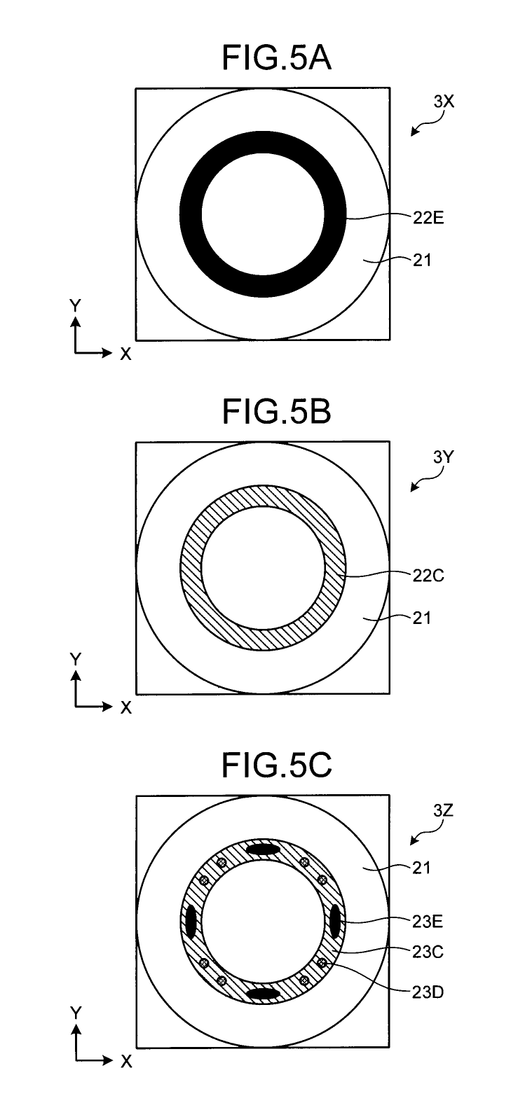

Here, an example of an annular light source shape calculated by the light source shape calculation device 1 will be described. FIG. 4 is a view illustrating light intensity set to a light source. FIGS. 5A to 5C are views showing examples of an annular light source shape calculated by the light source shape calculation device according to the first embodiment.

The light intensity set to a light source is set to a value in the range of “0” to “1.0,” for example. The light intensity of “1.0” is the maximum intensity that can be set to the light source, and the light intensity of “0” is the minimum intensity (without light source) that can be set to the light source. In the present embodiment, for the sake of description, a case where the light intensity is set to any one of the light intensity bands 20A to 20E shown in FIG. 4 will be described. The light intensity band 20A has a value in the range of “0” to “0.2.” Moreover, the light intensity band 20B has a value in the range of “0.2” to “0.4,” and the light intensity band 20C has a value in the range of “0.4” to “0.6.” Furthermore, the light intensity bands 20D has a value in the range of “0.6” to “0.8,” and the light intensity band 20E has a value in the range of “0.8” to “1.0.”

As shown in FIG. 5A, the light source shape calculation unit 13A calculates an annular light source shape 22E serving as an annular light source (Annular) 3X, having a calculated inner diameter and a calculated outer diameter. The annular light source shape 22E is a ring-shaped region and has light intensity in the light intensity band 20E. Moreover, a region 21 is a circular region in which a light source can be disposed. In addition, the light intensity of the annular light source shape calculated by the light source shape calculation unit 13A may fall within the light intensity bands 20A to 20D.

As shown in FIG. 5B, the light intensity correction unit 14A calculates an annular light source shape 22C of an annular light source 3Y. Specifically, the light intensity correction unit 14A decreases the light intensity of the annular light source shape 22E by half. In this way, the light intensity correction unit 14A calculates the annular light source shape 22C having a light intensity in the light intensity band 20C which is half the light intensity band 20E. The annular light source shape 22C has the same shape as the annular light source shape 22E. The annular light source shape 22C corresponds to the corrected annular light source shape P described above.

As shown in FIG. 5C, the point light source application unit 16 calculates annular light source shapes 23C to 23E of an annular light source 3Z. Specifically, the point light source application unit 16 calculates point light source shapes 23D and 23E as a set of point light sources capable of optimizing the process margin of the important pattern. The point light source shapes 23D and 23E are applied to the annular light source shape 22C, whereby the annular light source shape 22C becomes the annular light source shape 23C. The point light source shape 23D has a light intensity in the light intensity band 20D, and the point light source shape 23E has a light intensity in the light intensity band 20E. Moreover, the annular light source shape 23C has a light intensity in the light intensity band 20C similarly to the annular light source shape 22C. The annular light source shapes 23C to 23E corresponds to the optimized annular light source shape Q described above.

The position of the point light source applied to the annular light source shape 22C is not limited to a position in the same region as the annular light source shape 22C but may be located to any position within the region 21. Moreover, the point light source applied to the annular light source shape 22C may have any light intensity.

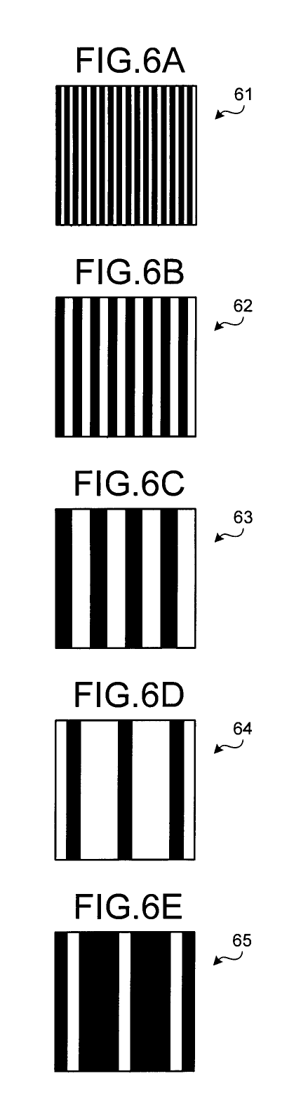

FIGS. 6A to 6E are views showing examples of a line-and-space pattern used as an allowed pattern. FIGS. 6A to 6E show the pattern layout of a line-and-space pattern. FIG. 6A shows a line-and-space pattern 61 having a small pattern pitch, and FIG. 6C shows a line-and-space pattern 63 having a large pattern pitch. Moreover, FIG. 6B shows a line-and-space pattern 62 having an average pattern pitch.

FIG. 6D shows a line-and-space pattern 64 in which the ratio of a line width to a space width is 1:3, and FIG. 6E shows a line-and-space pattern 65 in which the ratio of a line width to a space width is 3:1.

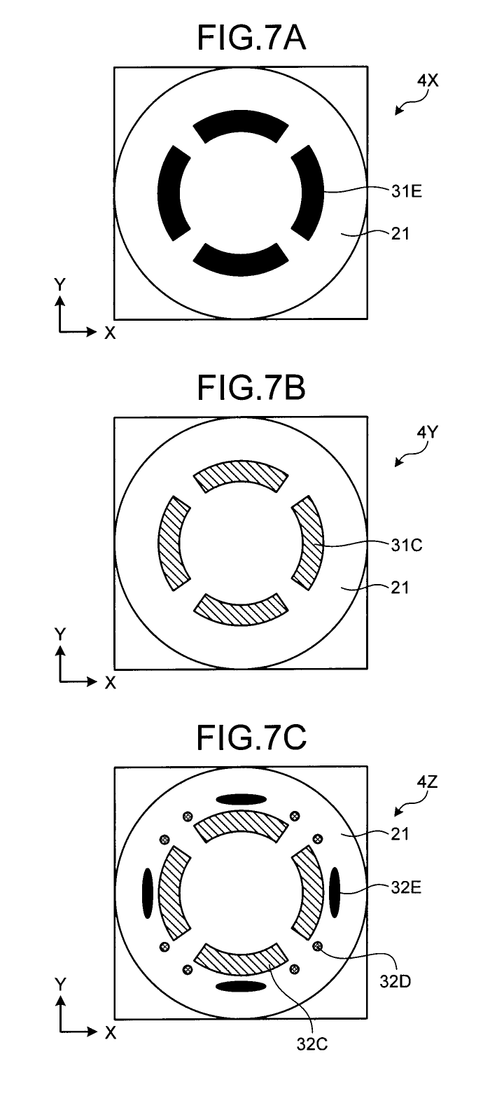

Here, an example of a four-eyed light source shape calculated by the light source shape calculation device 1 will be described. FIGS. 7A to 7C are views showing examples of a four-eyed light source shape calculated by the light source shape calculation device.

As shown in FIG. 7A, the light source shape calculation unit 13A calculates a four-eyed light source shape 31E serving as a four-eyed light source (C-quad) 4X, having a predetermined inner diameter, a predetermined outer diameter, an inner diameter-side arc length, and an outer diameter-side arc length. The four-eyed light source shape 31E is symmetric with respect to the X-axis direction and the Y-axis direction when the central position of the four-eyed light source shape 31E is regarded as the origin. Moreover, the four-eyed light source shape 31E has a light intensity in the light intensity band 20E. In addition, the light intensity of the four-eyed light source shape calculated by the light source shape calculation unit 13A may fall within the light intensity bands 20A to 20D.

As shown in FIG. 7B, the light intensity correction unit 14A derives a four-eyed light source shape 31C of the four-eyed light source 4Y. Specifically, the light intensity correction unit 14A decreases the light intensity of the four-eyed light source shape 31E by half, for example. In this way, the light intensity correction unit 14A calculates the four-eyed light source shape 31C having a light intensity in the light intensity band 20C which is half the light intensity band 20E. The four-eyed light source shape 31C has the same shape as the four-eyed light source shape 31E.

As shown in FIG. 7C, the point light source application unit 16 derives four-eyed light source shapes 32C to 32E of a four-eyed light source 4Z. Specifically, the point light source application unit 16 calculates point light source shapes 32D and 32E as a set of point light sources capable of making the process margin of the important pattern have a predetermined value or more (optimal value). The point light source shape 32D has a light intensity in the light intensity band 20D, and the point light source shape 32E has a light intensity in the light intensity band 20E. Moreover, the four-eyed light source shape 32C has a light intensity in the light intensity band 20C similarly to the four-eyed light source shape 31C.

The position of the point light source applied to the four-eyed light source shape 31C is not limited to a position in a different region than the four-eyed light source shape 31C but may be located to in the same region as the four-eyed light source shape 31C. Moreover, the point light source applied to the four-eyed light source shape 31C may have any light intensity.

Moreover, in the present embodiment, although a case in which the light source shape calculation unit 13A calculates the annular light source shape or the four-eyed light source shape has been described, the light source shape calculation unit 13A may calculate a light source shape having a shape different from these shapes.

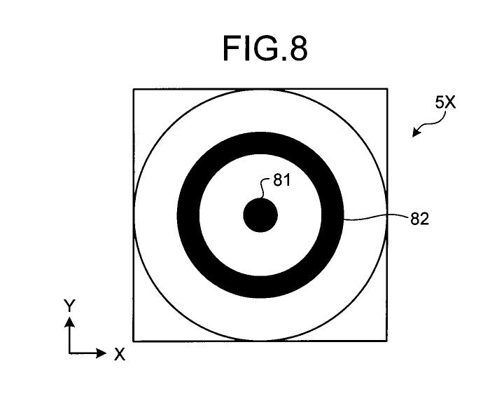

FIG. 8 is a view showing an example of another light source shape configured to include an annular light source shape. An example of another light source shape configured to include the annular light source shape includes a light source shape of a light source 5X. The light source 5X is a Soft Annular and has a shape in which a circular light source shape 81 is disposed on the inner side of an annular light source shape 82. The light source shape calculation unit 13A may calculate the light source shape of the light source 5X based on allowed patterns.

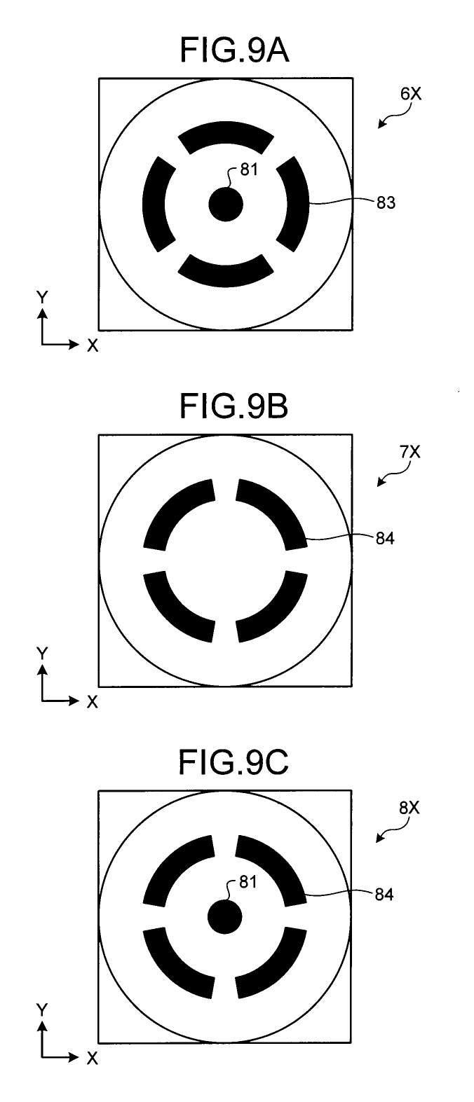

FIGS. 9A to 9C are views showing examples of another light source shape configured to include the four-eyed light source shape. An example of another light source shape configured to include the four-eyed light source shape includes light sources 6X, 7X, and 8X.

As shown in FIG. 9A, the light source 6X is a Soft C-quad and has a shape in which a circular light source shape 81 is disposed on the inner side of a four-eyed light source shape 83. Moreover, as shown in FIG. 9B, the light source 7X is a Quasar and has a four-eyed light source shape 84. The four-eyed light source shape 84 is disposed such that the four-eyed light source shape 83 is rotated by 45 degrees in the in-plane direction about the central position of the four-eyed light source shape 83. Thus, the four-eyed light source shape 84 is disposed at a different position in the in-plane direction from the four-eyed light source shape 83.

As shown in FIG. 9C, the light source 8X is a Soft Quasar and has a shape in which the circular light source shape 81 is disposed on the inner side of the four-eyed light source shape 84. The light source shape calculation unit 13A may calculate any one of the light sources 5X to 8X based on allowed patterns.

The source shape calculation process is performed for each layer of a wafer process, for example. Moreover, a semiconductor device (semiconductor integrated circuit) is manufactured using the light source shape calculated for each layer. Specifically, exposure is performed on a wafer on which a resist is applied using a mask in accordance with the calculated light source shape, and then, the wafer is developed to thereby form a resist pattern on the wafer. Moreover, the lower layer side of the wafer is etched using the resist pattern as a mask. In this way, an actual pattern corresponding to the resist pattern is formed on the wafer. When a semiconductor device is manufactured, the above-described source shape calculation process, exposure process, development process, and etching process, and the like are performed for each layer.

In the present embodiment, since the process margin is not optimized with respect to a finite number of input patterns, the calculated light source shape is not a set of point light sources. Moreover, since the annular light source shape or the four-eyed light source shape is calculated with respect to allowed patterns, it is possible to calculate a light source shape having symmetry with respect to the X-axis direction and the Y-axis direction. Therefore, no angle in which the light intensity is weak is present in the calculated light source shape, and it is possible to prevent the occurrence of a hot spot. Accordingly, there is no pattern layout in which the process margins of patterns allowed by design rules are weakened.

Moreover, since the point light source is applied based on the important pattern, it is possible to enhance the light intensity of a pattern shape that is important in device and process design. Therefore, it is possible to increase the process capability when manufacturing a semiconductor device.

As described above, since the light source shape is calculated using the allowed patterns and the important pattern, it is possible to optimize the light source shape robustly with a small number of pattern variation. Moreover, it is possible to decrease regression (repetition) of a calculation process during the source shape calculation process. Therefore, it is possible to shorten a process turn around time (TAT) of a light source shape optimization process.

Moreover, since the light source shape is calculated based on allowed patterns, it is possible to minimize the number of illumination light source shapes regardless of a design layout of each product.

As described above, since the light source shape is calculated based on allowed patterns and the important pattern, it is possible to improve the process margin of the important pattern and to transfer an integrated circuit pattern to a wafer without decreasing the process margin of a pattern having a pitch or orientation that is not used for the calculation. Therefore, it is possible to suppress the occurrence of a pattern which is not resolved and of which the process margin is not sufficient and to decrease a pattern shape error. Thus, it is possible to improve the product yield ratio.

As described above, according to the first embodiment, since the light source shape is calculated based on allowed patterns, and then, a point light source corresponding to an important pattern is applied to the calculated light source shape, it is possible to calculate a light source shape capable of enabling exposure to be performed appropriately with respect to all patterns allowed by design rules.

### Second Embodiment

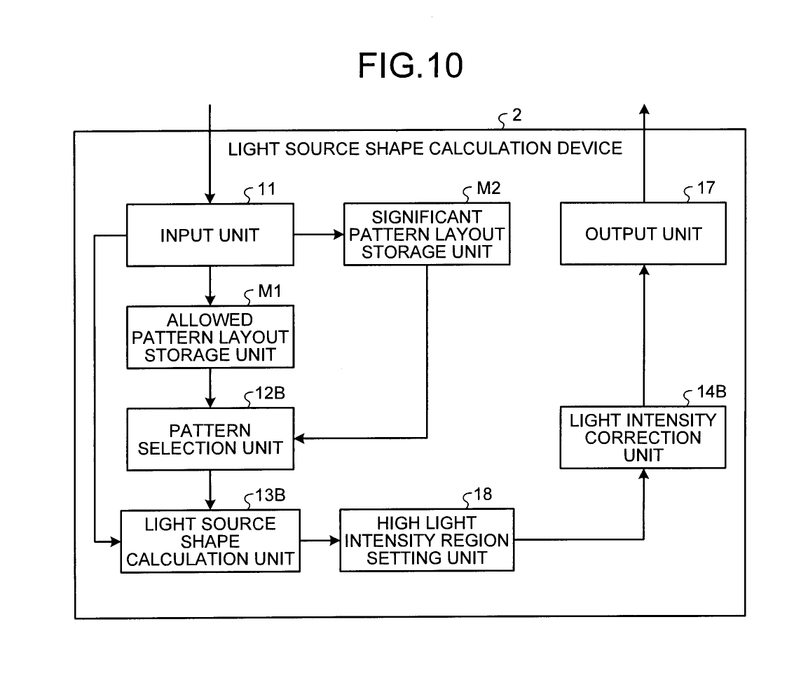

Next, a second embodiment of the invention will be described with reference to FIGS. 10 to 13. In the second embodiment, a light source shape configured by a set of point light sources is calculated based on allowed patterns and an important pattern. Moreover, an annular light source shape is derived by increasing the light intensity of a region (loop-shaped region) corresponding to the calculated light source shape.

FIG. 10 is a block diagram showing the configuration of a light source shape calculation device according to a second embodiment. Among the respective constituent elements of FIG. 10, the constituent elements performing the same functions as the light source shape calculation device 1 of the first embodiment shown in FIG. 1 are denoted by the same reference numerals, and redundant description thereof will not be repeated.

A light source shape calculation device 2 includes an input unit 11, a pattern selection unit 12B, a light source shape calculation unit 13B, a light intensity correction unit 14B, a high light intensity region setting unit 18, an output unit 17, an allowed pattern layout storage unit M1, and an important pattern layout storage unit M2.

The pattern selection unit 12B selects a pattern layout used for optimizing a light source shape from among the allowed patterns stored in the allowed pattern layout storage unit M1. For example, the pattern selection unit 12B selects a pattern layout used for optimizing a light source shape from among the important patterns stored in the important pattern layout storage unit M2. The pattern selection unit 12B sends the selected pattern layouts to the light source shape calculation unit 13B.

The light source shape calculation unit 13B has the same function as the light source shape calculation unit 13A. Moreover, the light intensity correction unit 14B has the same function as the light intensity correction unit 14A. The light source shape calculation unit 13B calculates a point light source shape based on the restriction conditions through simulation so as to optimize the process margin common to the pattern layouts selected by the pattern selection unit 12B. The light source shape calculation unit 13B of the present embodiment calculates a light source shape made up of point light sources based on allowed patterns and important patterns. The light source shape calculation unit 13B sends the calculated point light source shape to the high light intensity region setting unit 18.

The high light intensity region setting unit 18 extracts the position (coordinate) in which light intensities having a predetermined value (for example, 0.8) or more are distributed from within the point light source shape calculated by the light source shape calculation unit 13B. The high light intensity region setting unit 18 sets an annular light source shape region (hereinafter referred to as an annular region) so that the extracted position is included in the annular region.

Specifically, the annular region is set so that a point light source positioned on the outermost circumference (the coordinate farthest from the center of a region 21) within a point light source shape having a light intensity of a predetermined value or more is located on the outer diameter of the annular light source shape or closer to the inner circumference side than the outer diameter, and a point light source positioned on the innermost circumference (the coordinate closest to the center of the region 21) is located on the inner diameter of the annular light source shape or closer to the outer circumference side than the inner diameter.

In other words, the annular region is the range of polar coordinates expressed by (r,θ)=((r1,r2),(0≦θ2τ)) when the minimum distance from the center of a point light source is r1, and the maximum distance is r2. The high light intensity region setting unit 18 sends the set annular region to the light intensity correction unit 14B.

The light intensity correction unit 14B of the present embodiment corrects the light intensity at a position where the annular region set by the high light intensity region setting unit 18 has a light intensity of a first predetermined value (for example, 0.5) or less to a light intensity of a second predetermined value (for example, 0.5) or more. In this way, the entire region of the annular light source shape has a light intensity of the second predetermined value or more. The light intensity correction unit 14B sends the annular light source shape of which the light intensity is corrected to the output unit 17.

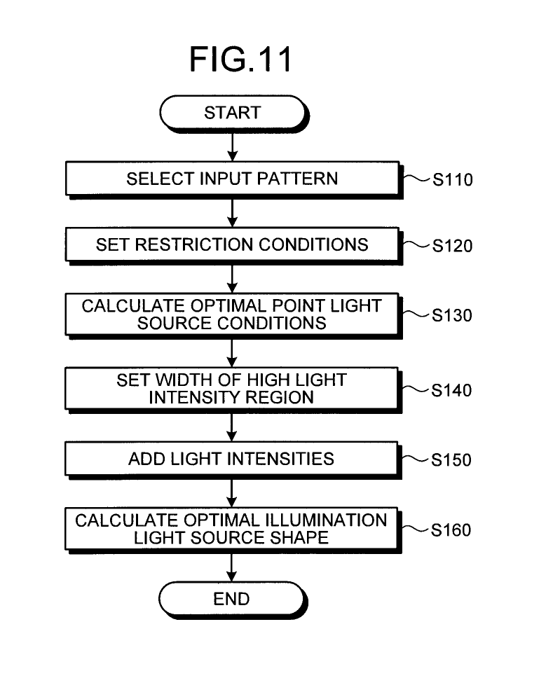

Next, the processing procedures of a source shape calculation process will be described. FIG. 11 is a flowchart showing the processing procedures of a light source shape calculation process according to the second embodiment. Among the processing procedures shown in FIG. 11, description of the same processes as the processes described in FIG. 2 will not be redundantly repeated.

The input unit 11 sends the input restriction conditions to the light source shape calculation unit 13B. The pattern selection unit 12B selects a pattern layout (input pattern) used for optimizing the light source shape from among the allowed patterns stored in the allowed pattern layout storage unit M1 (step S110). Moreover, the point light source application unit 12B selects a pattern layout (input pattern) used for optimizing the light source shape from among the important patterns stored in the allowed pattern layout storage unit M2 (step S110).

The pattern selection unit 12B sends the selected pattern layouts to the light source shape calculation unit 13B. The light source shape calculation unit 13B sets the restriction conditions regarding exposure (step S120). The light source shape calculation unit 13B calculates an optimal point light source shape based on the restriction conditions through simulation so that all of the respective pattern layouts selected from among the allowed patterns have a predetermined level of process margin or higher (step S130). The light source shape calculation unit 13B sends the calculated point light source shape to the high light intensity region setting unit 18.

The high light intensity region setting unit 18 extracts a point light source having a light intensity of a predetermined value (for example, 0.8) or more from within the point light source shape (a set of point light sources) calculated by the light source shape calculation unit 13B. The high light intensity region setting unit 18 sets an annular region (the inner and outer diameters) so that the extracted point light source is included in the annular region. In this way, the width of the annular region (high light intensity region) having the highest light intensity within the point light source is set (step S140). The high light intensity region setting unit 18 sends the set annular region to the light intensity correction unit 14B.

The light intensity correction unit 14B adds the light intensities within the annular region set by the high light intensity region setting unit 18 (step S150). In this way, the light intensity correction unit 14B calculates an optimal illumination light source shape (step S160).

Specifically, the light intensity correction unit 14B of the present embodiment corrects the light intensity at a position where the annular region set by the high light intensity region setting unit 18 has a light intensity of a first predetermined value (for example, 0.5) or less to a light intensity of a second predetermined value (for example, 0.5) or more. In this way, the entire region of the annular light source shape has a light intensity of the second predetermined value or more. The light intensity correction unit 14B sends the annular light source shape of which the light intensity is corrected to the output unit 17. The output unit 17 outputs the annular light source shape of which the light intensity is corrected to an external device or the like such as an exposure apparatus.

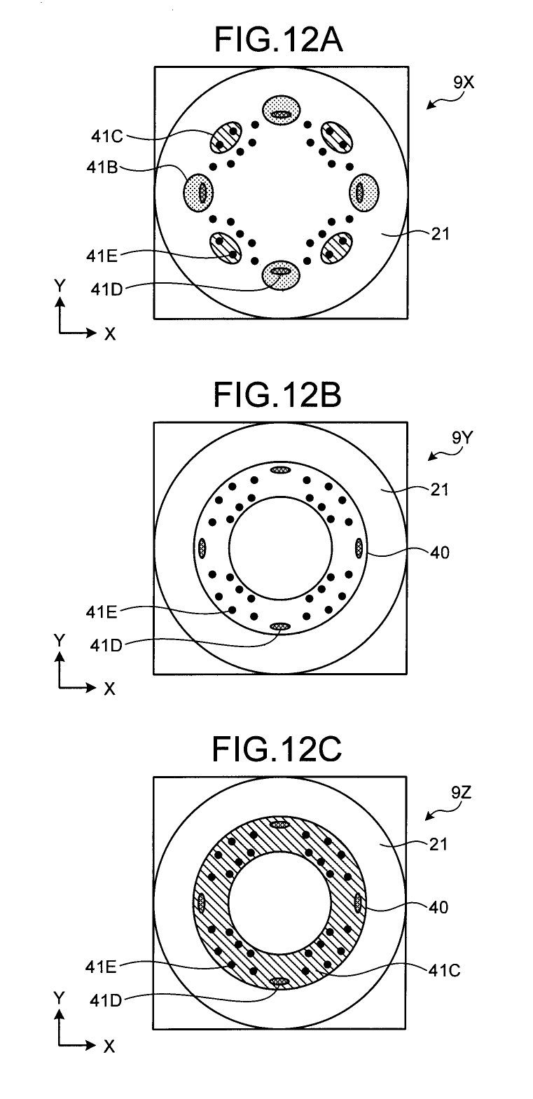

Here, an example of an annular light source shape calculated by the light source shape calculation device 2 will be described. FIGS. 12A to 12C are views showing examples of an annular light source shape calculated by the light source shape calculation device according to the second embodiment.

As shown in FIG. 12A, the light source shape calculation unit 13B calculates point light source shapes 41B, 41C, 41D, and 41E of a light source 9X. Specifically, the light source shape calculation unit 13B calculates the point light source shapes 41B, 41C, 41D, and 41E corresponding to allowed patterns and important patterns. The point light source shape 41B has a latching groove in the light intensity band 20B, and the point light source shape 41C has a light intensity in the light intensity band 20C. Moreover, the point light source shape 41D has a light intensity in the light intensity band 20D, and the point light source shape 41E has a light intensity in the light intensity band 20E.

As shown in FIG. 12B, the high light intensity region setting unit 18 sets a light source 9Y. Specifically, the high light intensity region setting unit 18 extracts the point light sources 41D and 41E having a light intensity in the light intensity band 20D or more, for example, from among the point light source shapes 41B to 41E calculated by the light source shape calculation unit 13B. Moreover, the high light intensity region setting unit 18 sets an annular region 40 so that all the extracted point light sources 41D and 41E are included in the smallest region (the annular region 40) of the annular light source shape. In this case, the high light intensity region setting unit 18 sets the annular region 40 so that the annular region 40 has the smallest area, for example.

As shown in FIG. 12C, the light intensity correction unit 14B calculates a light source 9Z. Specifically, the light intensity correction unit 14B sets the light intensity at a position where the annular region 40 has a light intensity in the light intensity band 20C or less, for example, to be in the light intensity band 20C. In this way, the entire region of the annular region 40 has a light intensity in the light intensity band 20C or more. Moreover, the point light source shapes 41D and 41E having a light intensity in the light intensity bands 20D and 20E are included in the annular region 40.

By optimizing the light source shape in this way, it is possible to improve the process margin needed for an integrated circuit pattern using a normal annular light source. Moreover, it is possible to prevent a decrease in the process margins of non-selected pattern layouts rather than the light source shape optimized by only the pattern layout selected first. Therefore, it is not necessary to increase the number of pattern layouts (input patterns) selected first.

### Hardware Configuration

Next, a hardware configuration of the light source shape calculation devices 1 and 2 will be described. Since the light source shape calculation devices 1 and 2 have the same hardware configuration, in this example, the hardware configuration of the light source shape calculation device 1 will be described.

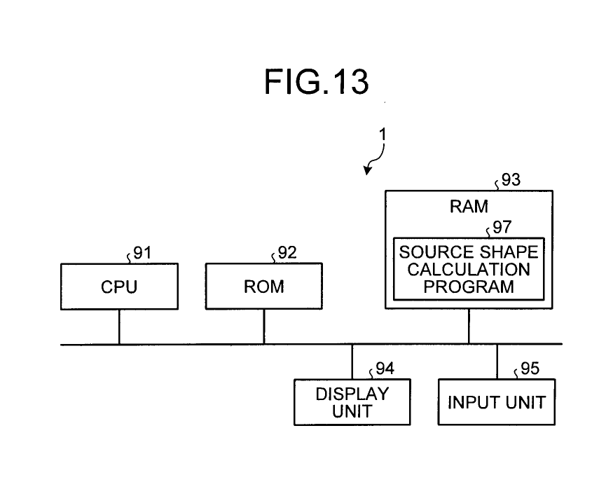

FIG. 13 is a view showing a hardware configuration of the light source shape calculation device. The light source shape calculation device 1 includes a central processing unit (CPU) 91, a read only memory (ROM) 92, a random access memory (RAM) 93, a display unit 94, and an input unit 95. In the light source shape calculation device 1, the CPU 91, the ROM 92, the RAM 93, the display unit 94, and the input unit 95 are connected through a bus line.

The CPU 91 calculates an illumination light source shape using a light source shape calculation program 97 which is a computer program. The display unit 94 is a display device such as a liquid crystal monitor and displays an allowed pattern, an important pattern, an annular light source shape calculated by the light source shape calculation unit 13A, an annular light source shape of which the light intensity is corrected by the light intensity correction unit 14A, an annular light source shape calculated by the point light source application unit 16, and the like based on an instruction from the CPU 91. The input unit 95 is configured to include a mouse or a keyboard and receives instruction information (parameters necessary for calculating light source shapes) input from the user. The input information input to the input unit 95 is sent to the CPU 91.

The light source shape calculation program 97 is stored in the ROM 92 and is load into the RAM 93 through the bus line. FIG. 13 shows a state in which the light source shape calculation program 97 is loaded into the RAM 93.

The CPU 91 executes the light source shape calculation program 97 loaded into the RAM 93. Specifically, in the light source shape calculation device 1, the CPU 91 reads the light source shape calculation program 97 from the ROM 92, expands the light source shape calculation program 97 in a program storage area within the RAM 93, and executes various processes in response to the instruction from the input unit 95 input by the user. The CPU 91 temporarily stores various data generated during the various processes in the data storage area formed in the RAM 93.

The light source shape calculation program 97 executed by the light source shape calculation device 1 has a modular configuration including the pattern selection unit 12A, the light source shape calculation unit 13A, the light intensity correction unit 14A, the important pattern application unit 15, and the point light source application unit 16, and these units are loaded onto a main storage device and generated on the main storage device.

The light source shape calculation device 2 described in the second embodiment has the same hardware configuration as the light source shape calculation device 1. The light source shape calculation program 97 executed by the light source shape calculation device 2 has a modular configuration including the pattern selection unit 12B, the light source shape calculation unit 13B, the light intensity correction unit 14B, and the high light intensity area setting unit 18.

In the present embodiment, although a case in which the high light intensity area setting unit 18 sets an annular region has been described, the high light intensity area setting unit 18 may set the four-eyed light source shape region. In this case, the light intensity correction unit 14B increases the light intensity of the four-eyed light source shape to a predetermined level or higher. Moreover, in the present embodiment, although the point light source shape is calculated based on the allowed pattern and the important pattern, the point light source shape may be calculated based on the allowed pattern.

As described above, according to the second embodiment, since an annular light source shape corresponding to a point light source shape is set after the point light source shape is calculated based on the allowed pattern and the important pattern, it is possible to calculate light source shapes enabling exposure to be appropriately performed with respect to all patterns allowed by the design rules.

As described above, according to the first and second embodiments, it is possible to calculate light source shapes enabling exposure to be appropriately performed with respect to all patterns allowed by the design rules.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light source shape calculation method comprising:
calculating a first light source shape as an exposure illumination light source shape based on at least two pattern layouts defined by design rules used when manufacturing a semiconductor device, so that the first light source shape has a light source shape region symmetrical to an X-axis direction and a Y-axis direction, and a process margin of formation of an on-substrate pattern corresponding to the at least two pattern layouts is optimized;
applying a pattern layout to be formed on the semiconductor device to the at least two pattern layouts to thereby create a combined pattern layout;
calculating a point light source based on the combined pattern layout so that the process margin of formation of the on-substrate pattern corresponding to the pattern layout formed on the semiconductor device is optimized; and
calculating a second light source shape in which the point light source is applied to the first light source shape.

2. The light source shape calculation method according to claim 1,
wherein the first light source shape includes an annular light source shape at least partially in the light source shape.

3. The light source shape calculation method according to claim 1,
wherein the first light source shape includes a four-eyed light source shape at least partially in the light source shape.

4. The light source shape calculation method according to claim 1,
wherein the first light source shape has a uniform light intensity distribution which is continuous within the first light source shape region.

5. The light source shape calculation method according to claim 1,wherein the method involves, before the calculating the second light source shape, correcting the light intensity of the first light source shape by decreasing the light intensity of the first light source shape by a predetermined amount or by a predetermined proportion,
wherein the method calculates the second light source shape in which the point light source is applied to the first corrected light source shape.

6. The light source shape calculation method according to claim 1,
wherein the pattern layout formed on the semiconductor device includes at least one of a frequent pattern and an internal memory pattern.

7. The light source shape calculation method according to claim 1,
wherein the at least two pattern layouts are patterns which include two or more pattern pitches.

8. The light source shape calculation method according to claim 1,
wherein the first and second light source shapes are calculated based on restriction conditions regarding exposure.

9. The light source shape calculation method according to claim 8,
wherein the restriction conditions regarding exposure include at least one of exposure conditions applied to an exposure apparatus, characteristics of the exposure apparatus, and mask types.

10. The light source shape calculation method according to claim 1,
wherein the point light source has a predetermined light intensity at each position of the point light source.

11. The light source shape calculation method according to claim 3,
wherein the four-eyed light source shape is a C-quad.

12. The light source shape calculation method according to claim 3,
wherein the four-eyed light source shape is a Quasar.

13. The light source shape calculation method according to claim 2,
wherein the first light source shape is a Soft Annular in which a circular light source shape is disposed on the inner side of the annular light source shape.

14. The light source shape calculation method according to claim 11,
wherein the first light source shape is a Soft C-Quad in which a circular light source shape is disposed on the inner side of the C-quad.

15. The light source shape calculation method according to claim 12,
wherein the first light source shape is a Soft Quasar in which a circular light source shape is disposed on the inner side of the Quasar.

16. A light source shape calculation method comprising:
applying a pattern layout to be formed on a semiconductor device to at least two pattern layouts defined by design rules used when manufacturing the semiconductor device to thereby create a combined pattern layout;
calculating a first light source shape which is made up of a set of point light sources based on the combined pattern layout as an exposure illumination light source shape so that a process margin when forming an on-substrate pattern corresponding to the combined pattern layout is optimized;
setting an annular light source shape region in a region corresponding to the distribution of the point light sources; and
calculating a second light source shape in which a region having a light intensity lower than a first light intensity within the annular light source shape region is set to a second light intensity higher than the first light intensity.

17. The light source shape calculation method according to claim 16, further comprising:
extracting a position in which light intensities of a predetermined value or more are distributed from the first light source shape; and
setting the annular light source shape region so that the extracted position is included in the annular light source shape region.

18. The light source shape calculation method according to claim 16,
wherein the pattern layout formed on the semiconductor device includes at least one of a frequent pattern and an internal memory pattern.

19. The light source shape calculation method according to claim 16,
wherein the at least two pattern layouts are patterns which include two or more pattern pitches.

20. The light source shape calculation method according to claim 16,
wherein the first light source shape is calculated based on restriction conditions regarding exposure.
